(19) United States
(12) Patent Application Publication
(10) Pub. No.: US 2007/0185742 A1
(43) Pub. Date: Aug. 9, 2007

(54) Securitized insurance or insurance-like protection

(76) Inventors: Stephen Chapin, Mamaroneck, NY (US); Michael Shane Hadden, Greenwich, CT (US); Caitlin F. Long, New York, NY (US)

Correspondence Address: CLIFFORD CHANCE US LLP, 31 WEST 52ND STREET, NEW YORK, NY, 10019-6131, US

(21) Appl. No.: 11/521,697

(22) Filed: Sep. 15, 2006

Related U.S. Application Data
(60) Provisional application No. 60/717,618, filed on Sep. 15, 2005.

(51) Int. Cl. G06Q 40/00

(52) U.S. Cl. 705/4; 705/38

(57) ABSTRACT

A method of securitized insurance or insurance like protection is provided that eliminates accounting mismatches created when an institution such as a bank, insurance company or corporation wishes to gain protection for an outstanding obligation of payment. An insurance or insurance like protection is purchasable by the institution that protects the institution's outstanding obligation with a structure that can be accounted for on an accrual basis. The accrual basis protection creates accounting conformity for the institution when matched with the accrual accounting basis of the obligation.

### CROSS REFERENCE TO RELATED APPLICATIONS

This application claims priority to U.S. Provisional Application No. 60/717,618, filed Sep. 15, 2005.

### BACKGROUND OF THE INVENTION

In the aim of achieving financial protection, it is generally true that (i) banks desire to purchase credit protection on loans that they have made; (ii) insurance companies desire to purchase (a) reinsurance protection on risks assumed under insurance policies they have issued (e.g., workers compensation, trade credit, surety) and (b) retrocessional protection on risks assumed under reinsurance agreements they have entered into; and (iii) corporations that are neither banks nor insurers desire to purchase credit protection on obligations of third parties to the corporation (e.g., trade receivables, lease obligations). In some cases, these banks, insurers and other corporations would prefer to obtain such credit and other protection by purchasing an insurance product rather than a derivative. Obtaining protection through the insurance product may be preferable because most insurance products are typically accounted for on an “accrual basis,” meaning receivables and payables are accounted for when an exchange of receivables and payables is agreed to or is owed, and the assets and liabilities that such entities seek to hedge through the purchase of such protection are likewise accounted for on an accrual basis. In comparison, derivatives typically are accounted for on a “mark-to-market basis,” meaning the value assigned to a position held in a financial instrument is based on the current market price for that instrument, or on a fair valuation based on the current market prices of similar instruments. Consequently, if these banks, insurers and other corporations were to purchase such protection in the form of derivatives, they would be subject to an accounting mismatch. Accordingly, financial benefits may be obtained by the use of products providing for financial protection without, e.g., accounting mismatches or other disadvantages present in conventional instruments.

Prior existing methods and structures do not solve this issue. For example, one recent transaction that exemplifies the limitations of the prior art involved the co-issuers Smart Home Reinsurance 2005-1 Limited and Smart Home Credit 2005-1 Limited (the “Smart Home Deal”). The Smart Home Deal provided reinsurance protection for a portion of Radian Guaranty Inc.'s mortgage insurance portfolio. Like “catastrophe bonds” issued over the past ten years, the Smart Home Deal provided reinsurance protection only and not direct insurance. In addition, the Smart Home Deal provided protection on mortgage risk only, and not a broader array of credit risks (in either financial guaranty insurance or reinsurance form) as is available through the present invention.

Standard credit default swaps (“CDS”) are likewise limited. CDSs generally are required to be marked to market under FASB Statement No. 133, Accounting for Derivative Instruments and Hedging Activities (“FAS 133”), creating an accounting mismatch. In addition, standard CDSs do not protect specific obligations of an insured but only specific reference entities. Hence, the specific obligations that the credit protection buyer is seeking to protect may not be deliverable into a standard CDS in settlement, e.g. trade receivables. Furthermore, a market does not exist for protecting certain kinds of risk with standard CDSs, such as surety insurance and middle market corporate names.

Collateralized debt obligations (“CDO”) require an insured party sell an insured portfolio into a special purpose entity. However there are good accounting, tax, and relationship reasons for the insured party to buy “synthetic” credit protection rather than selling the assets it wants to protect into a CDO vehicle. Additionally, such synthetic protection can result in substantial savings for the insured party as the super senior tranche of protection can be done in less expensive, un-funded form.

Non-Standard Credit Default Swaps (“NCDS”) may be structured to be financial guaranty contracts under FAS 133 and, as such, qualify for accrual accounting. However, these non-standard credit default swaps leave the protection seller with the risk that it has sold unlicensed financial guaranty insurance. In addition, as noted above in reference to standard CDSs, a market does not exist for protecting certain kinds of risk using non-standard CDSs, such as surety insurance and middle market corporate names.

Sometimes an insurance company, or cell within an insurance company, issues an insurance policy and hedges the risk under the policy by buying CDS protection (“Transformer Trades”). Transformer Trades, however, have basis risk in that the insurance protection that they provide will only pay claims to the extent that a payment is due to the cell or insurance company under the CDS and the amount paid through its settlement is enough to cover the claims that are made. In addition, Transformer Trades are expensive relative to the protection available through the present invention. Transformer Trades are priced at a premium to the cost of a corresponding CDS, often in excess of 10 basis points per annum. This is because the “transforming” insurance company or some entity within the structure must be paid for the “balance sheet usage” and the accounting mismatch (between the CDS purchased and the insurance sold) in addition to the cost of the underlying CDS that it buys as a hedge. Finally, Transformer Trades are only available to the extent the CDSs they transform are available for a given name or risk.

Synthetic CDOs, like standard CDSs, are not eligible for accrual accounting. Any payments to an insured party are based on CDS valuations that effectively accelerate the loss payments made under synthetic CDOs. This creates an expensive policy.

Except for investment-grade municipal obligations, financial guaranty insurance of this type (i.e., first loss, single-name protection) is not available from existing financial guaranty insurance companies. One reason for this is that most of these insurers subscribe to a highly levered, “zero-loss” strategy. Hence, these insurers do not provide first loss, single name insurance protection for which some losses are expected.

There remains a need for a way to securitize an assumed obligation that does not create an accounting mismatch and that provides a first loss, single name protection for which some losses are expected.

### SUMMARY OF THE INVENTION

The invention provides a way of delivering insurance or insurance like protection on corporate loan portfolios, thereby providing coverage for corporate risk while not creating accounting mismatches, and further overcomes the limitations of the prior art.

According to an embodiment of the present invention, it includes a method of securitized protection providing a conformity of accrual based accounting structures having the steps of (1) assuming an obligation in one or a multiplicity of single name credit exposures, wherein the obligation is assumed by an institution, (2) accounting for the obligation on an accrual basis, (3) purchasing an insurance policy for the institution from an insurance company in exchange for insurance premiums such that the institution is also a policy holder, and (4) accounting for the insurance policy on an accrual basis, wherein the insurance policy provides single name credit protection for the obligation and wherein the institution is a bank, a second insurance company or a corporation.

According to another embodiment of the invention, it includes a method of providing insurance or insurance like protection on corporate loan portfolios having the steps of (1) drafting a policy such that the policy qualifies for accrual accounting treatment afforded to a financial guaranty contract sunder FAS 133, (2) issuing the policy to an institution in exchange for insurance premiums such that the institution is also a policyholder, (3) designating at least one single name credit protection under the policy for an at least one obligation assumed by the institution, wherein (4) the at least one single name obligation is accounted on an accrual basis.

These and other features and advantages of the present invention may be realized by one or ordinary skill in the art by reference to the remaining portions of this specification, the drawings and the claims.

### BRIEF DESCRIPTION OF THE DRAWINGS

FIG. 1 is a block diagram of a single tranche structure involving a letter of credit issued by a bank.

FIG. 2 is a block diagram of a single tranche structure involving issuance of an insurance policy by an insurance company.

FIG. 3 is a block diagram of a dual tranche structure involving a bank and an insurance company.

FIG. 4 is a block diagram of a triple tranche structure involving a bank, an insurance company and an equity investor.

FIG. 5 is a block diagram of a dual tranche structure involving an LoC beneficiary.

FIG. 6 is a block diagram of a triple tranche structure involving an LoC beneficiary.

### DETAILED DESCRIPTION OF THE DRAWINGS

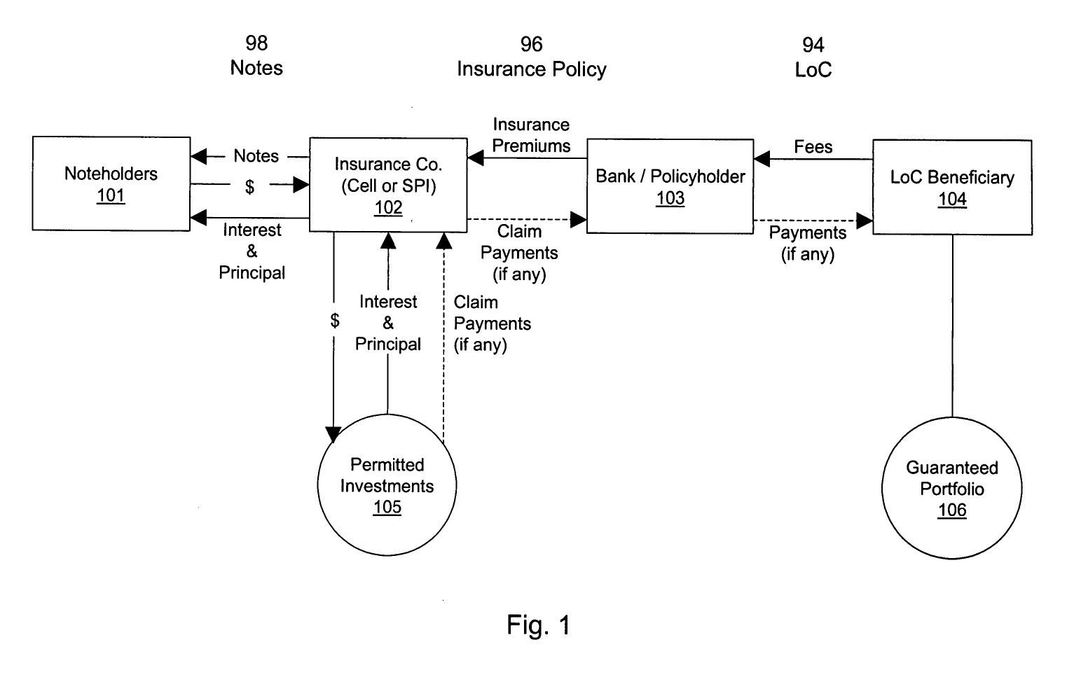

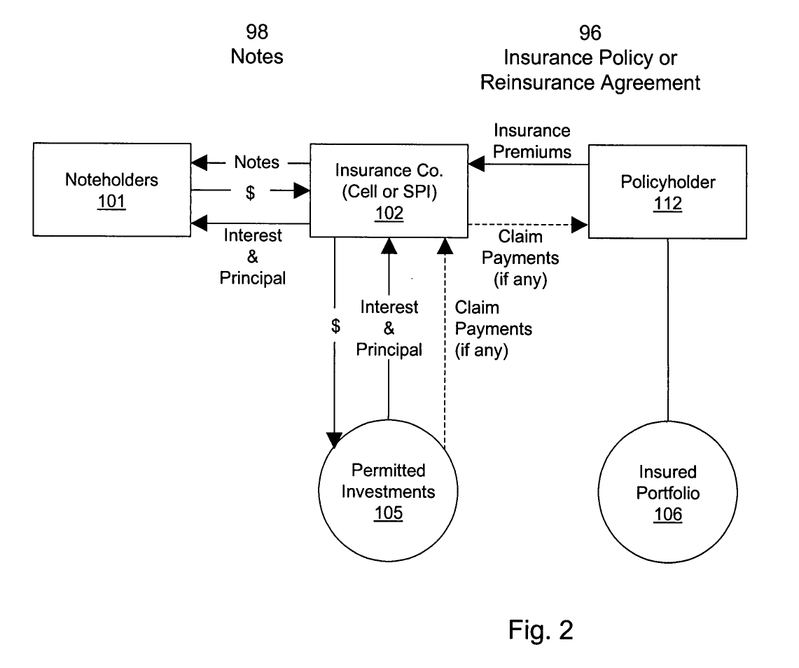

In one embodiment of the invention, as shown in FIG. 1 and generally shown in FIGS. 2-6, the invention provides an insurance company 102 that will likely have a bankruptcy-remote structure, although bankruptcy remoteness is not strictly necessary. Potential bankruptcy-remote structures include, but are not limited to, a segregated cell or separate account of an insurance company (a “cell”,) or a special purpose insurance company (an “SPI”.) From the general account of insurance company 102 (if an SPI) or from the bankruptcy-remote part of insurance company 102, e.g., from cell, insurance company 102 would (a) provide a form of insurance or reinsurance protection Policy 96 and (b) issue obligations, such as Notes 98, which may be in different classes with differing priorities of payment and interest rates (i.e., tranches). Notes 98 may be “linked” to credit performance of an portfolio 106 of debt obligations, the timely payment of principal and interest on which is covered by the Policy 96. As used herein, the terms “Cell”, “SPI” and “Insurance Company” are interchangeable in that one term can be substituted for the others while maintaining the spirit of the invention.

The proceeds of the Notes 98 are invested in permitted investments 105, i.e., collateral, that provides security for Policy 96 that insurance company 102 writes to the holder of the portfolio 106. These permitted investments 105 might include a note or repurchase contract linked to the portfolio 106, or other securities or instruments. To the extent necessary, the permitted investments 105 would be limited to investments that allow the holder of Policy 96 to receive the desired credit relief and/or regulatory capital benefit from Policy 96.

Insurance company 102, the form of Policy 96, the domicile of Note 98 investors, and other details of the invention's structure are may be specified with the goal of minimizing the risk of withholding tax being imposed on premiums paid under Policy 96. For example, instead of taking the form of a traditional insurance policy, Policy 96 may be embedded in a note or structured repurchase contract such that payments on the policy are treated as interest rather than guarantee payments. The details of each invention structure are also arranged to comply with any insurance and/or banking regulations that might apply. As used herein, the term “policy” may be either a traditional insurance policy or a guarantee embedded in a note, thereby providing either insurance or insurance-like protection. The invention provides coverage at a lower cost because it benefits from technology used in the securitization market that has not previously been applied to large credit portfolios on an accrual accounting basis.

FIG. 1 depicts a single tranche structure involving a letter of credit, or similar banking product, issued by a bank. FIG. 1 shows (i) the issuance by a bank (the “Bank”) 103 of a guaranty, loan, letter of credit or other similar banking product (collectively, the “LoC” 94) to an end buyer of protection (the “LoC Beneficiary” 104), wherein this transaction is accounted for on an accrual basis, (ii) the issuance of a financial guaranty insurance policy (the “Policy” 96) by a special purpose insurance company or the cell of an insurance company (the “Cell” 102) to Bank 103 to hedge the risk associated with portfolio (the “Guaranteed Portfolio” 106) that is assumed by Bank 103 under LoC 94, and (iii) the issuance by Cell 102 of notes to investors 101 (the “Notes”). Under LoC 94, Bank 103 makes guarantee payments on claims (if any) that LoC Beneficiary 104 made as a result of losses LoC Beneficiary 104 incurred on obligations covered by LoC 94. In consideration for this protection, LoC Beneficiary 104 typically pays to Bank 103 (a) an initial issuance fee and (b) ongoing fees over the life of LoC 94.

Under Policy 96, Cell 102 pays for any claims that Bank 103, as policyholder, made as a result of losses that Bank 103 incurred on obligations based on Guaranteed Portfolio 106 and covered by Policy 96. This coverage can be for a single name credit protection exposure such that Policy 96 covers a single name credit exposure obligation derived from a single Guaranteed Portfolio 106. In consideration for this protection, Bank 103 pays an insurance premium to Cell 102, typically over the life of Policy 96. Policy 96 is insurance (i.e., an insurable interest and proof of loss is required of the policyholder) such that it is not marked to market over time for accounting purposes. Instead, Policy 96 is designed to qualify for accrual accounting treatment afforded to a financial guaranty contract under FAS 133. The accrual accounting of the Policy 96 matches the accrual accounting for the Bank 103 obligation assumed under LoC 94, thereby eliminating accounting mismatches and creating accounting conformity. This unique attribute of the invention distinguishes it from competing products currently available to hedge portfolio credit risk that must be marked to market under FAS 133. The Cell will pay claims made under Policy 96 solely through the assets it holds (i.e., Permitted Investments 105), and earnings thereon. Bank 103, as the insured party under Policy 96, will have a first priority security interest in Permitted Investment 105. All recoveries that Bank 103 receives on defaulted obligations covered by LoC 94, and for which Bank 103 has already received insurance claim payments under Policy 96, will be forwarded by Bank 103 to Cell 102. Cell 102 will then invest such funds in Permitted Investment 105.

Interest due on Notes 98 is paid out of (i) earnings on the Permitted Investments 105 and (ii) premiums paid by Bank 103 to Cell 102 under Policy 96. Notes 98 are redeemed at maturity in the order of their seniority, with the most senior notes being redeemed first and the most subordinate notes being redeemed last. Permitted Investments 105 are sold to fund redemptions. If there are any claim payments made under Policy 96, it is likely that there will not be enough Permitted Investments 105 at redemption to return the principal amount of all Notes 98. The Cell 102 pays interest on Notes 98 based upon the amount of outstanding principal balance of Notes 98 over the period that interest is due. The outstanding principal balance is generally calculated as (i) the purchase price of Notes 98; minus (ii) amounts due under any insured obligation covered by Policy 96 that have not been paid; plus (iii) any recoveries of amounts described in clause (ii). On the maturity date of Notes 98, Noteholders 101 receive the outstanding principal balance, if any, on the Notes.

The invention will be structured to give Bank 103 as much flexibility in Policy 96 as Bank 103 requires and the investors in Notes 98 will tolerate, subject to limitations imposed by Noteholders 101 and accounting requirements necessary to maintain the non-mark-to-market treatment of Policy 96 and the related LoC 94. The invention may permit Bank 103 (i) to substitute any obligation in the Guaranteed Portfolio (i.e., an obligation covered by Policy 96) with another non-defaulted and pari passu obligation of the same obligor, (ii) to reduce premium and coverage under Policy 96 for any obligation in Guaranteed Portfolio 106 that is redeemed or terminated by the respective issuer, and (iii) to reduce premium and coverage under Policy 96 for any obligation in Guaranteed Portfolio 106 that LoC Beneficiary 104 elects to sell out of the Guaranteed Portfolio, subject to the condition that it no longer holds any similar obligation of that obligor at that point in time. These three features add to the flexibility of the structure from the Insured Party's point of view and clearly distinguish the invention from other competing structures to hedge portfolio credit risk.

FIG. 2 depicts a single tranche structure of an insurance or reinsurance agreement. FIG. 2 shows (i) the issuance of an insurance Policy 96 by a Cell 102 of an insurance company or special purpose insurance company to a Policyholder 112 to hedge the risk associated with Insured Portfolio 106, wherein Insured Portfolio 106 is a portfolio of debt obligation assembled by Policyholder 112 and (ii) the issuance by Cell 102 of Notes 98. Policy 96 could provide life, property & casualty, mortgage, financial guaranty or other forms of insurance coverage. Notes 98 may be credit linked if Policy 96 provides financial guaranty insurance protection. Alternatively, Notes 98 may not be credit linked, but have recourse only to Cell 102. Accounting based on the Policyholder's is accrual based both for Policy 96 and obligation assumed under Insured Portfolio 106. Policy 96 can be for single name credit protection such that Policy 96 covers a single name credit exposure obligation derived from Insured Portfolio 106.

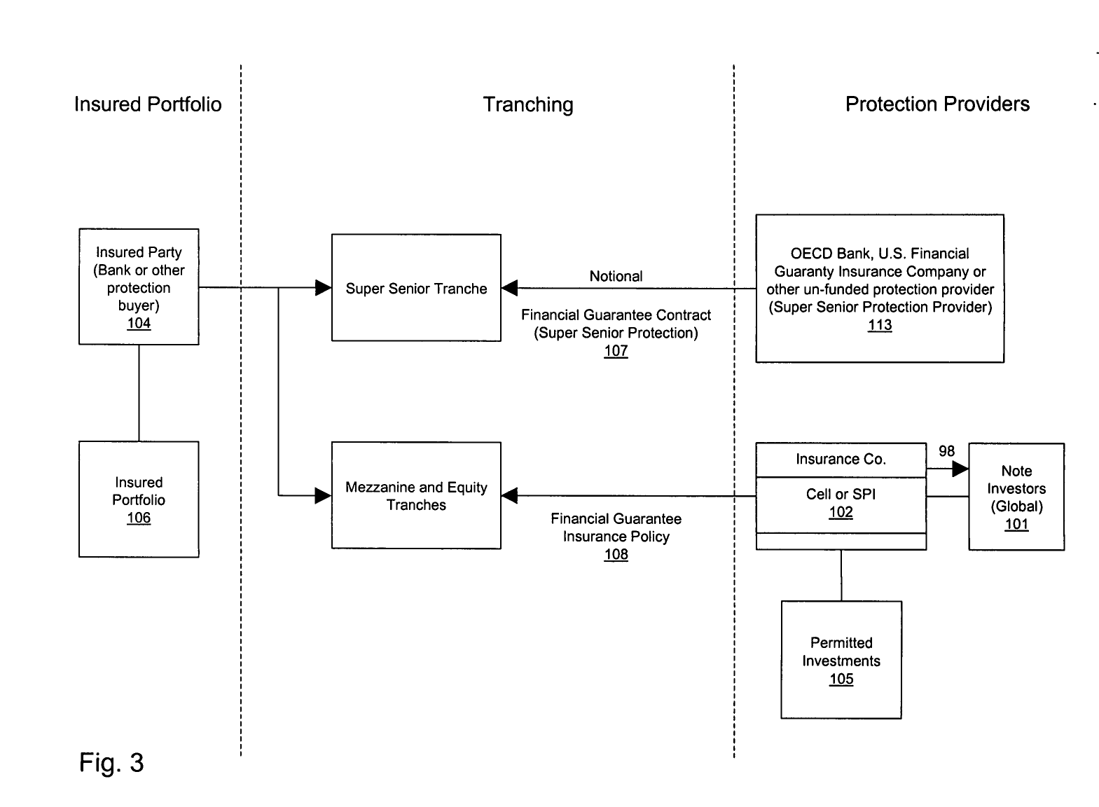

FIG. 3 depicts a dual tranche structure. FIG. 3 shows (i) (a) the issuance by an OECD bank, U.S. financial guaranty insurance company or other un-funded protection provider 113 of a guaranty, loan, letter of credit, other similar banking product or financial guaranty insurance policy, as the case may be, (“Super Senior Protection” 107) to Insured Party 104, wherein this transaction is accounted for on an accrual basis and wherein Insured Party 104 is an end buyer of protection and (b) the issuance of a financial guaranty insurance Policy 108 by a segregated account of an insurance company or special purpose insurance company (“Cell” 102) to Insured Party 104, in the case of both (a) and (b), to hedge the risk associated with Insured Portfolio 106, wherein Insured Portfolio 106 is a portfolio of debt obligations assumed by the Insured Party 104 and accounted for on an accrual basis, and (ii) the issuance by Cell 102 of Notes 98 to Noteholders 101. Policy 108 can be for single name credit protection such that Policy 108 covers a single name credit exposure obligation derived of Insured Part 104 from Insured Portfolio 106.

Under Super Senior Protection 107, Bank 113 makes guarantee payments on claims (if any) that Insured Party 104 made as a result of losses Insured Party 104 incurred on obligations covered by Super Senior Protection 107 i.e., Insured Portfolio 106. In consideration for this protection, Insured Party 104 typically pays to Bank 113, the Super Senior Protection Provider, (a) an initial issuance fee and/or (b) ongoing fees or premiums over the life of Super Senior Protection 107.

Under Policy 108, Cell 102 pays claims that Insured Party 104, as policyholder, made as a result of losses Insured Party 104 incurred on obligations covered by Policy 108, i.e., the Insured Portfolio 106. In consideration for this protection, Insured Party 104 pays an insurance premium to Cell 102, typically over the life of Policy 108. Since Policy 108 is insurance (i.e., an insurable interest and proof of loss is required of the policyholder), it is not marked to market over time for accounting purposes. Instead, Policy 108 is designed to qualify for accrual accounting treatment afforded to a financial guaranty contract under FAS 133. From the perspective of Insured Party 104, the accounting basis of Policy 108, Insured Portfolio 106 and Super Senior Protection 107 are all accrual basis, thereby eliminating accounting mismatches and creating accounting conformity. Cell 102 will pay claims made under Policy 108 solely through the assets it holds (i.e., Permitted Investments 105), and earnings thereon. Insured Party 104, as the owner of Policy 108, will have a first priority security interest in Permitted Investments 105. All recoveries that Insured Party 104 receives on defaulted obligations within its Insured Portfolio 106, for which Insured Party 104 has already received insurance claim payments under Policy 108, will be forwarded by Insured Party 104 to Cell 102. Cell 102 will then invest such finds in Permitted Investments 105.

Interest due on Notes 98 is paid out of (i) earnings on Permitted Investments 105 and (ii) premiums paid by Insured Party 104 to Cell 102 under Policy 108. Notes 98 are redeemed at maturity in the order of their seniority, with the most senior notes being redeemed first and the most subordinate notes being redeemed last. Permitted Investments 105 are sold to fund redemptions. If there are any claim payments made under Policy 108, in a typical embodiment, it is likely that there will not be enough Permitted Investments 105 at redemption to return the face amount of all Notes 98. Cell 102 pays interest on Notes 98 based upon the amount of outstanding principal balance of Notes 98 on the day that interest is due. The outstanding principal balance is generally calculated as (i) the purchase price of Notes 98; minus (ii) amounts due under any insured obligation covered by Policy 108 that have not been paid by the applicable obligor; plus (iii) any recoveries of amounts described in clause (ii). On the maturity date of Notes 98, the Noteholders 101 receive the outstanding principal balance, if any, on the Notes.

Preferably, the invention will be structured to give Insured Party 104 as much flexibility in Policy 108 as Insured Party 104 requires and the investors in Notes 98 will tolerate, subject to limitations imposed by holders of Notes 98 and accounting requirements necessary to maintain the non-mark-to-market treatment of Policy 108. The invention may permit Insured Party 104 (i) to substitute any obligation in the Insured Portfolio 106 (i.e., an obligation covered by Policy 108) with another obligation of the same obligor and (ii) to reduce premium and coverage under Policy 108 for any obligation in Insured Portfolio 106 that is redeemed or terminated by the respective issuer. These two features add to the flexibility of the structure from Insured Party 104's perspective and distinguish the invention from other competing structures to hedge portfolio credit risk.

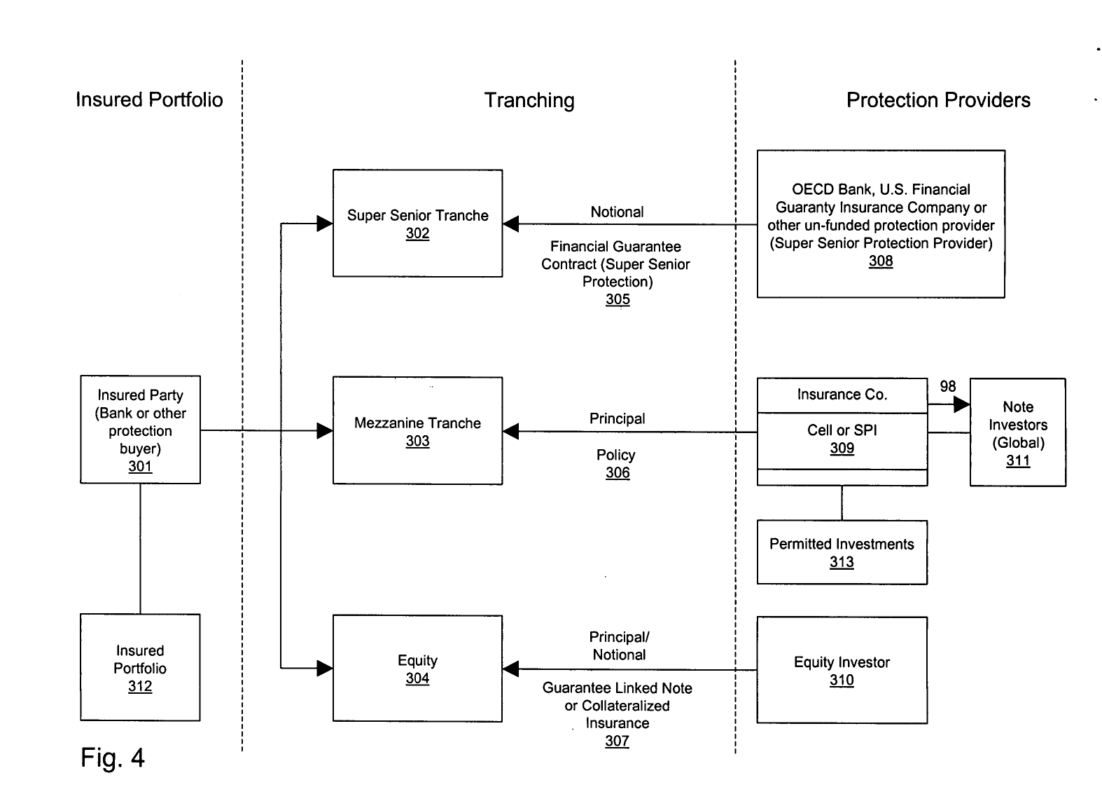

FIG. 4 depicts a triple tranche structure having Super Senior Tranche 302, Mezzanine Tranche 303 and Equity Tranche 304. FIG. 4 shows (i) the issuance by an OECD bank, U.S. financial guaranty insurance company or other un-funded protection provider 308 (Super Senior Protection Provider 308) of a guaranty, letter of credit, other similar banking product or financial guaranty insurance policy, as the case may be, “Super Senior Protection” 305 to Insured Party 301, wherein this transaction is accounted for on an accrual basis and wherein Insured Party 301 is an end buyer of protection, (ii) a guarantee linked repurchase agreement of debt securities or guarantee linked note (Policy 306) entered into between a segregated account of an insurance company or special purpose insurance company (Cell 309) and Insured Party 301, wherein this transaction is accounted for on an accrual basis, (iii) the issuance by Cell 309 of Notes 98 to note investors 311 and (iv) the issuance of guarantee linked notes or the purchase of collateralized insurance (Guarantee Linked Notes 307) by Insured Party 301 to or from equity investors 310, wherein this transaction is also accounted for on an accrual basis. Super Senior Protection 305, Policy 306 and the Guarantee Linked Notes 306 hedge the risks associated with a portfolio of Insured Portfolio 312, wherein Insured Portfolio 312 are risk and loans issued or assumed by Insured Party 301). From the perspective of Insured Party 301, the accounting basis of Policy 306, Insured Portfolio 312, Guarantee Linked Notes 307 and Super Senior Protection 305 and are all accrual basis, thereby eliminating accounting mismatches and creating accounting conformity. Further, Policy 306 can be for single name credit protection such that it covers a single name credit exposure obligation of Insured Party 301 derived from Insured Portfolio 312, a feature that insurance companies presently do not provide.

Under Super Senior Protection 305, Super Senior Protection Provider 308 makes guarantee payments on claims (if any) that Insured Party 301 made as a result of losses incurred on the obligations covered by the Super Senior Protection 305, i.e., Insured Portfolio 312, after protection provided by the Policy 306 and Guaranty Linked Notes 307. In consideration for this protection, Insured Party 301 typically pays to Super Senior Protection Provider 308 (a) an initial issuance fee and/or (b) ongoing fees or premiums over the life of the Super Senior Protection 305.

In one embodiment, under Policy 306, if Policy 306 is a repurchase agreement, Insured Party 301 agrees to repurchase the underlying debt securities from Cell 309 at a price that would be reduced to reflect losses by Insured Party 301 incurred on Insured Portfolio 312, after first-loss protection provided by the Guarantee Linked Notes 307.

Interest due on Notes 98 is paid out of (i) earnings on the Permitted Investments 313 and (ii) premiums paid by Insured Party 301 to Cell 309 under Repurchase Agreement 306. Notes 98 are redeemed at maturity in the order of their seniority, with the most senior notes being redeemed first and the most subordinate notes being redeemed last. Permitted Investments 313 are sold to fund any redemptions. If there are any claim payments made under Repurchase Agreement 306, it is likely that there will not be enough Permitted Investments 313 at redemption to return the face amount of all Notes 98. Cell 309 pays interest on Notes 98 based upon the amount of outstanding principal balance of the Notes on the day that interest is due. The outstanding principal balance is generally calculated as (i) the purchase price of Notes 98; minus (ii) the reduction in the purchase price reflected in Repurchase Agreement 306. On the maturity date of Notes 98, Note investors 311 receive the outstanding principal balance, if any, on the Notes.

Insured Party 301 pays interest on Guarantee Linked Notes 307 based upon the amount of outstanding principal balance of Guarantee Linked Notes 307 on the day that interest is due. The outstanding principal balance is generally calculated as (i) the purchase price of Guarantee Linked Notes 307; minus (ii) amounts due under obligations in Insured Portfolio 312 that have not been paid by the applicable obligor; plus (iii) any recoveries of amounts described in clause (ii). On the maturity date of Guarantee Linked Notes 307, the holders of the Guarantee Linked Notes 307 receive the outstanding principal balance, if any, on the Guarantee Linked Notes 307.

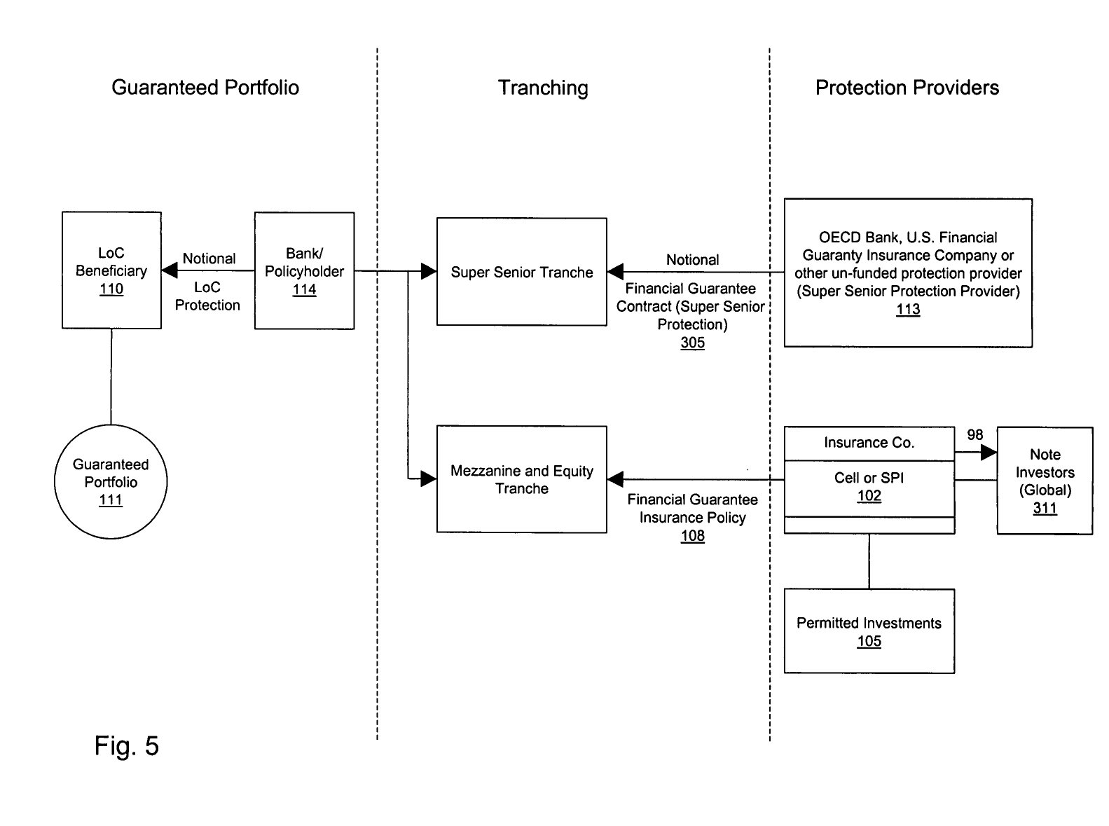

FIG. 5 depicts a dual tranche structure involving a letter of credit, or similar banking product, issued by a bank. FIG. 5 shows (i) (a) the issuance by an OECD bank, U.S. financial guaranty insurance company or other un-funded protection provider 113 of a guaranty, letter of credit, other similar banking product or financial guaranty insurance policy, as the case may be, (Super Senior Protection 305) to Insured Party 114, wherein Insured Party 114 is a bank or other policyholder and this transaction is accounted for on an accrual basis, (b) the issuance by Insured Party 114 of a guaranty, letter of credit or other similar banking product (collectively, LoC Protection 115 to LoC Beneficiary 110, wherein this transaction is accounted for on an accrual basis and wherein LoC Beneficiary 110 is an end buyer of protection and (c) the issuance of a financial guaranty insurance Policy 108 by a segregated account of an insurance company or special purpose insurance company (Cell 102) to Insured Party 114, to hedge the risk associated with Guaranteed Portfolio 111, wherein Guaranteed Portfolio 111 is a portfolio of debt obligations assumed by Insured Party 114, and (ii) the issuance by Cell 102 of Notes 98 to Note investors 311.

Under Super Senior Protection 305, the Super Senior Protection Provider 113 makes guarantee payments on claims (if any) that Insured Party 114 made as a result of losses Insured Party 114 incurred on obligations covered by Super Senior Protection 305 i.e., Guaranteed Portfolio 111. In consideration for this protection, Insured Party 114 typically pays to the Super Senior Protection Provider 113 (a) an initial issuance fee and/or (b) ongoing fees or premiums over the life of Super Senior Protection 305.

Under Policy 108, the Cell pays claims that Insured Party 114 made as a result of losses Insured Party 114 incurred on obligations covered by Policy 108, i.e., losses incurred by the LoC Beneficiary 110 under Guaranteed Portfolio 111. This coverage can be for a single name credit protection such that Policy 108 covers a single name obligation exposure derived from a single Guaranteed Portfolio 111. In consideration for this protection, Policy 108 holder pays an insurance premium to Cell 102, typically over the life of Policy 108. Since Policy 108 is insurance (i.e., an insurable interest and proof of loss is required of Insured Party 114), it is not marked to market over time for accounting purposes. Instead, Policy 108 is designed to qualify for accrual accounting treatment afforded to a financial guaranty contract under FAS 133. From the perspective of Insured Party 114, the accounting basis of Policy 108 and obligations derived from Guaranteed Portfolio 111 under the Letter of Credit and are all accrual basis, thereby eliminating accounting mismatches and creating accounting conformity. Cell 102 will pay claims made under Policy 108 solely through the assets it holds, i.e., Permitted Investments 105, and earnings thereon. Insured Party 114 will have a first priority security interest in Permitted Investments 105. All recoveries that Insured Party 114 receives on defaulted obligations within Guaranteed Portfolio 111, for which Insured Party 114 has already received insurance claim payments under Policy 108, will be forwarded by the Insured Party to Cell 102. Cell 102 will then invest such funds in Permitted Investments 105.

Interest due on Notes 98 is paid out of (i) earnings on Permitted Investments 105 and (ii) premiums paid by Insured Party 114 to Cell 102 under Policy 108. The Notes are redeemed at maturity in the order of their seniority, with the most senior notes being redeemed first and the most subordinate notes being redeemed last. Permitted Investments 105 are sold to fund redemptions. If there are any claim payments made under Policy 108, in a typical embodiment, it is likely that there will not be enough Permitted Investments 105 at redemption to return the face amount of all Notes 98. Cell 102 pays interest on Notes 98 based upon the amount of outstanding principal balance of the Notes on the day that interest is due. The outstanding principal balance is generally calculated as (i) the purchase price of Notes 98; minus (ii) amounts due under any insured obligation covered by Policy 108 that have not been paid by the applicable obligor; plus (iii) any recoveries of amounts described in clause (ii). On the maturity date of the Notes 98, the Note investors 311 receive the outstanding principal balance, if any, on the Notes.

Preferably, the invention will be structured to give Insured Party 114 as much flexibility in Policy 108 as the Insured Party 114 requires and the investors in Notes 98 will tolerate, subject to limitations imposed by Note investors 311 and accounting requirements necessary to maintain the non-mark-to-market treatment of Policy 108. The invention may permit Insured Party 114 (i) to substitute any obligation in the Guaranteed Portfolio 111 (i.e., an obligation covered by Policy 108) with another obligation of the same obligor and (ii) to reduce premium and coverage under Policy 108 for any obligation in the Guaranteed Portfolio 111 that is redeemed or terminated by the respective issuer. These two features add to the flexibility of the structure from the Insured Party 114's perspective.

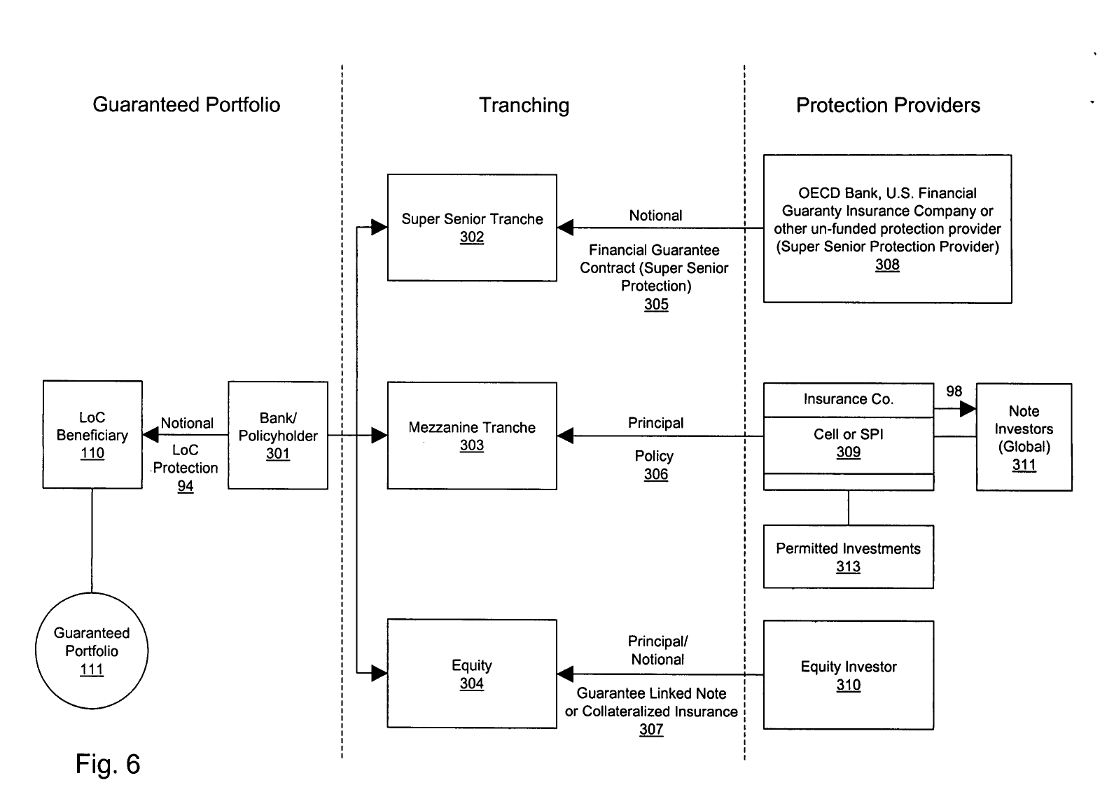

FIG. 6 depicts a triple tranche structure having Super Senior Tranche 302, Mezzanine Tranche 303 and Equity Tranche 304 and involving a letter of credit, or similar banking product, issued by a bank. FIG. 6 shows (i) the issuance by an OECD bank, U.S. financial guaranty insurance company or other un-funded protection provider (Super Senior Protection Provider 308) of a guaranty, letter of credit, other similar banking product or financial guaranty insurance policy, as the case may be, Super Senior Protection 305 to Insured Party 301, wherein Insured Party 301 is a bank or other policyholder, (b) the issuance by Insured Party 301 of a LoC guaranty, letter of credit or other similar banking product, collectively LoC Protection 94 to LoC Beneficiary 110, wherein LoC Beneficiary 110 is an end buyer of protection, (ii) a guarantee linked repurchase agreement of debt securities or guarantee linked note (Policy 306) entered into between a segregated account of an insurance company or special purpose insurance company (Cell 309) and Insured Party 301, (iii) the issuance by Cell 309 of Notes 98 to Note investors 311 and (iv) the issuance of guarantee linked notes or the purchase of collateralized insurance (Guarantee Linked Notes 307) by Insured Party 301 to or from equity investors 310. Super Senior Protection 305, Policy 306 and Guarantee Linked Notes 307 hedge the risk associated with Guaranteed Portfolio 111, wherein Guaranteed Portfolio 111 is a portfolio of debt obligations assumed by Insured Party 301. Policy 306 can be for a single name credit protection such that it covers a single name credit exposure obligation derived from LoC 94 and Guaranteed Portfolio 111. Like the above, from the perspective of Insured Party 301, all relevant accounting basis are accrual basis, thereby eliminating accounting mismatches and creating accounting conformity.

Under Super Senior Protection 305, Super Senior Protection Provider 308 makes guarantee payments on claims (if any) that Insured Party 301 made as a result of losses Insured Party 301 incurred on obligations covered by Super Senior Protection 305 i.e., the Guaranteed Portfolio 111 after protection provided by Policy 306 and Guaranty Linked Notes 307. In consideration for this protection, Insured Party 301 typically pays to the Super Senior Protection Provider 308 (a) an initial issuance fee and/or (b) ongoing fees or premiums over the life of Super Senior Protection 305.

In one embodiments, under Policy 306, if Policy 306 is a repurchase agreement, Insured Party 301 agrees to repurchase the underlying debt securities from Cell 309 at a price that would be reduced to reflect losses of Insured Party 301 incurred on Guaranteed Portfolio 111, after first-loss protection provided by the Guarantee Linked Notes 307.

Interest due on Notes 98 is paid out of (i) earnings on Permitted Investments 313 and (ii) premiums paid by Insured Party 301 to Cell 309 under Policy 306. Notes 98 are redeemed at maturity in the order of their seniority, with the most senior notes being redeemed first and the most subordinate notes being redeemed last. Permitted Investments 313 are sold to find any redemptions. If there are any claim payments made under Repurchase Agreement 306, it is likely that there will not be enough Permitted Investments 313 at redemption to return the face amount of all Notes 98. Cell 309 pays interest on Notes 98 based upon the amount of outstanding principal balance of the Notes on the day that interest is due. The outstanding principal balance is generally calculated as (i) the purchase price of Notes 98; minus (ii) the reduction in the purchase price reflected in the Repurchase Agreement. On the maturity date of Notes 98, the Note investors 311 receive the outstanding principal balance, if any, on the Notes.

Insured Party 301 pays interest on Guarantee Linked Notes 307 based upon the amount of outstanding principal balance of Guarantee Linked Notes 307 on the day that interest is due. The outstanding principal balance is generally calculated as (i) the purchase price of the Guarantee Linked Notes 307; minus (ii) amounts due under obligations in Guaranteed Portfolio 111 that have not been paid by the applicable obligor; plus (iii) any recoveries of amounts described in clause (ii). On the maturity date of Guarantee Linked Notes 307, the holders of the Guarantee Linked Notes (Equity Investor 310) receive the outstanding principal balance, if any, on the Guarantee Linked Notes

It will be appreciated that the present invention provides a securitized transaction structured to give the Insured Party as much flexibility in the Super Senior Protection, the Repurchase Agreement, the Guarantee Linked Notes and Policy as the Insured Party requires and the investors in the Notes will tolerate, subject to limitations imposed by holders of the Notes and accounting requirements necessary to maintain the non-mark-to-market treatment of the Super Senior Protection. For example, the invention will permit the Insured Party (i) to substitute any obligation in the Insured Portfolio with another insured obligation of the same obligor, (ii) to reduce premium and coverage under the Super Senior Protection, and (iii) adjust the terms of the Repurchase Agreement, the Guarantee Linked Notes and Policy to reflect any obligation in the Insured Portfolio that is redeemed or terminated by the respective issuer. These two features add to the flexibility of the structure from the Insured Party's perspective and distinguish the invention from other competing structures to hedge portfolio credit risk.

A number of embodiments of the present invention have been described. Nevertheless, it will be understood that various modifications may be made without departing from the spirit and scope of the invention. For example, although a particular securitized insurance protection structure has been described, implementations may involve alternative methods for the buyer of protection to obtain the desired coverage and accounting treatment. In addition, implementations may alter the form of the Notes and insurance policy or reinsurance agreement. Accordingly, other embodiments are within the scope of the invention.

We claim:

1. A method of securitized protection providing a conformity of accrual based accounting structures, comprising the steps of:
assuming an obligation in one or a multiplicity of single name credit exposures, wherein the obligation is assumed by an institution,
accounting for the obligation on an accrual basis,
purchasing an insurance policy for the institution from an insurance company in exchange for insurance premiums such that the institution is also a policy holder and
accounting for the insurance policy on an accrual basis,
wherein the insurance policy provides single name credit protection for the obligation.

2. The method of securitized protection of claim 1, wherein the insurance company is a cell or special purpose insurance company.

3. The method of securitized protection of claim 1, further comprising the step of the institution substituting any obligation in the one or a multiplicity of single name credit exposures with at least or a multiplicity of other non-defaulted and pari passau obligation.

4. The method of securitized protection of claim 1, wherein the institution is selected from the list consisting of a bank, a second insurance company and a corporation.

5. The method of securitized protection of claim 1, wherein the obligation assumed is represented by one or a multiplicity of letters of credit given to a letters of credit beneficiary, wherein the letters of credit are selected from the list consisting of a guaranty, letter of credit, surety, loan or a combination thereof.

6. The method of securitized protection of claim 1, further comprising the step of a super senior protection provider providing a super senior protection to the institution in exchange for payment, wherein the super senior protection provides coverage on claims that the institution is obliged to make as a result of the obligation in exchange for payment, such that the institution can account for the super senior protection on an accrual basis, and wherein the super senior protection provider is selected from the list consisting of an OECD bank, U.S. financial guaranty insurance company and un-funded protection provider.

7. The method of securitized protection of claim 6, wherein the super senior protection is selected from the list consisting of a guaranty, letter of credit, surety, loan or a combination thereof.

8. The method of securitized protection of claim 6, further comprising the step of a purchase of one or a multiplicity of guaranteed linked notes by the institution from one or a multiplicity of equity partners, wherein the one or a multiplicity of guaranteed linked notes provide first loss protection and is accounted by the institution on an accrual basis.

9. The method of securitized protection of claim 8, wherein the guaranteed linked notes are linked notes or collateralized insurance.

10. The method of securitized protection of claim 1, further comprising the steps of:
investment of the insurance premiums by the insurance company into permitted investments,
issuance of notes from the insurance company to note investors in exchange for payment,
paying interest due on the notes from earning on the permitted investments and insurance premiums.

11. The method of securitized protection of claim 1, wherein the insurance policy is structured as a note or a guarantee embedded in a note.

12. A method of providing insurance or insurance like protection on corporate loan portfolios, comprising the steps of:
drafting a policy such that the policy qualifies for accrual accounting treatment afforded to a financial guaranty contract sunder FAS 133,
issuing the policy to an institution in exchange for insurance premiums such that the institution is also a policyholder,
designating at least one single name credit protection under the policy for an at least one obligation assumed by the institution,
wherein the at least one single name obligation is accounted on an accrual basis.

13. The method of securitized protection of claim 12, wherein the insurance company is a cell or special purpose insurance company.

14. The method of securitized protection of claim 12, further comprising the step of the institution substituting any at least one single name obligation with at least one other non-defaulted and pari passau obligation.

15. The method of securitized protection of claim 12, wherein the institution is selected from the list consisting of a bank, a second insurance company and a corporation.

16. The method of securitized protection of claim 12, wherein the at least one obligation assumed by the institution is represented by one or a multiplicity of letters of credit given to a letters of credit beneficiary, wherein the letters of credit are selected from the list consisting of a guaranty, letter of credit, surety, loan or a combination thereof.

17. The method of securitized protection of claim 12, further comprising the step of a super senior protection provider providing a super senior protection to the institution in exchange for payment, wherein the super senior protection provides coverage on claims that the institution is obliged to make as a result of at least one obligation in exchange for payment, such that the institution can account for the super senior protection on an accrual basis, and wherein the super senior protection provider is selected from the list consisting of an OECD bank, U.S. financial guaranty insurance company and un-funded protection provider.

18. The method of securitized protection of claim 17, wherein the super senior protection is selected from the list consisting of a guaranty, letter of credit, surety, loan or a combination thereof.

19. The method of securitized protection of claim 18, further comprising the step of a purchase of one or a multiplicity of guaranteed linked notes by the institution from one or a multiplicity of equity partners, wherein the one or a multiplicity of guaranteed linked notes provide first loss protection and is accounted by the institution on an accrual basis.

20. The method of securitized protection of claim 19, wherein the guaranteed linked notes are linked notes or collateralized insurance.

21. The method of securitized protection of claim 20, further comprising the steps of:
investment of the insurance premiums by the insurance company into permitted investments,
issuance of notes from the insurance company to note investors in exchange for payment,
paying interest due on the notes from earning on the permitted investments and insurance premiums.

22. The method of securitized protection of claim 12, wherein the insurance policy is structured as a guarantee embedded in a note
